(19) United States
(12) Patent Application Publication
(10) Pub. No.: US 2024/0160470 A1
(43) Pub. Date: May 16, 2024

(54) METHOD OF DEPLOYING MICROSERVICE AND EDGE DEVICE

(71) Applicant: INSTITUTE FOR INFORMATION INDUSTRY, Taipei City (TW)

(72) Inventors: Xaver CHEN, Taipei City (TW); Wei-Jen WANG, Taipei City (TW)

(73) Assignee: INSTITUTE FOR INFORMATION INDUSTRY, Taipei City (TW)

(21) Appl. No.: 18/070,306

(22) Filed: Nov. 28, 2022

(30) Foreign Application Priority Data
Nov. 16, 2022 (TW) 111143669

(51) Int. Cl. G06F 9/48

(52) U.S. Cl. CPC G06F 9/4856; G06F 9/4881

(57) ABSTRACT

A method of deploying microservice includes: determining whether a current load of a task queue of a target edge host is not smaller than a load alert level; if the current load is not smaller than the load alert level, calculating a task migration number of a first queue of the task queue to deploy a microservice corresponding to the first queue at at least one of a first available edge host and a cloud host; if the current load is smaller than the load alert level, calculating a long-term load according to a history pushing rate, a history consumption rate and a default time period; and when a sum of the long-term load and a current load of a second queue of the task queue is not smaller than the load alert level, deploying a microservice corresponding to the second queue at a second available edge host.

### CROSS-REFERENCE TO RELATED APPLICATIONS

This non-provisional application claims priority under 35 U.S.C. § 119(a) on Patent Application No(s). 111143669 filed in Republic of China (ROC) on Nov. 16, 2022, the entire contents of which are hereby incorporated by reference.

### BACKGROUND

### 1. Technical Field

This disclosure relates to a method of deploying microservice and edge device, especially to a method of deploying microservice and edge device adapted to cloud-fog collaboration.

### 2. Related Art

In the field of cloud-fog collaboration, application may be deployed at the computing nodes at edge side by Function-as-a-Service (FaaS) to have better responding duration, and may be expanded to cloud computing resources. FaaS is a distributed system built by many microservices, wherein each microservice corresponds to a respective task queue, and the microservice is a stateless software element.

However, in a situation where the computing node at edge side has failure, the computation is likely to be delayed due to the failure or task accumulation. In a situation where tasks accumulate, the system may become overloaded. In addition, except for the failure of the computing node at edge side, system overload might also happen because of the task type etc., and it is difficult to troubleshoot the failure and overload problems in real time.

### SUMMARY

Accordingly, this disclosure provides a method of deploying microservice and edge device.

According to one or more embodiment of this disclosure, a method of deploying microservice, performed by an edge device, includes: determining whether a current load of each of at least one task queue of a target edge host is not smaller than a load alert level; when the current load of a first queue among the at least one task queue is not smaller than the load alert level, calculating a task migration number according to a history pushing rate, a history consumption rate, and a full consumption rate of the first queue, and deploying at least one microservice corresponding to the first queue at at least one of at least one first available edge host and at least one cloud host according to the task migration number; when the current load of each of the at least one task queue is smaller than the load alert level, calculating a long-term load of each of the at least one task queue according to a history pushing rate, a history consumption rate, and a default time period of a corresponding task queue, and determining whether a sum of the current load and the long-term load of the corresponding task queue is not smaller than the load alert level; and when the sum of the current load and the long-term load of a second queue among the at least one task queue is not smaller than the load alert level, calculating the task migration number according to the history pushing rate, the history consumption rate, and a full consumption rate of the second queue, and deploying at least one microservice corresponding to the second queue at at least one second available edge host.

According to one or more embodiment of this disclosure, an edge device includes: a monitoring module, a decision module and a communication module. The monitoring module is configured to monitor operating status of a target edge host and a current load of each of at least one task queue of a target edge host. The decision module connected to the monitoring module and is configured to perform: determining whether the current load of each of the at least one task queue of a target edge host is not smaller than a load alert level; when the current load of a first queue among the at least one task queue is not smaller than the load alert level, calculating a task migration number according to a history pushing rate, a history consumption rate, and a full consumption rate of the first queue, and deploying at least one microservice corresponding to the first queue at at least one of at least one first available edge host and at least one cloud host through the communication module according to the task migration number; when the current load of each of the at least one task queue is smaller than the load alert level, calculating a long-term load of each of the at least one task queue according to a history pushing rate, a history consumption rate, and a default time period of a corresponding task queue, and determining whether a sum of the current load and the long-term load of the corresponding task queue is not smaller than the load alert level; and when the sum of the current load and the long-term load of a second queue among the at least one task queue is not smaller than the load alert level, calculating the task migration number according to the history pushing rate, the history consumption rate, and a full consumption rate of the second queue, and deploying at least one microservice corresponding to the second queue at at least one second available edge host through the communication module.

Through the above structure, the method of deploying microservice and edge device of the present disclosure may perform monitoring for short-term (for example, immediately) overload and long-term overload, and transfer the task of the original edge host with short-term overload to other edge hosts or use cloud computing resources, thereby avoiding a new task entering the queue being rejected or abandoned; and transfer the task of the original edge host with long-term overload to other edge hosts, thereby avoiding a future problem of task accumulation, allowing problems to be dealt with before they develop into serious immediate overload.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram illustrating operation environment of an edge device according to an embodiment of the present disclosure;

FIG. 2 is a flowchart illustrating a method of deploying microservice according to an embodiment of the present disclosure;

FIG. 3A is a flowchart illustrating a short-term overload configuration strategy of a method of deploying microservice according to an embodiment of the present disclosure;

FIG. 3B is a flowchart illustrating a short-term overload configuration strategy of a method of deploying microservice according to another embodiment of the present disclosure;

FIG. 3C is a flowchart illustrating a short-term overload configuration strategy of a method of deploying microservice according to yet another embodiment of the present disclosure;

FIG. 4 is a flowchart illustrating a cost calculation method in the short-term overload configuration strategy of a method of deploying microservice according to an embodiment of the present disclosure;

FIG. 5 is a flowchart illustrating a long-term overload configuration strategy of a method of deploying microservice according to an embodiment of the present disclosure;

FIG. 6 is a flowchart illustrating a failure configuration strategy of a method of deploying microservice according to an embodiment of the present disclosure;

FIG. 7 is a flowchart illustrating a cost calculation method in the failure configuration strategy of a method of deploying microservice according to an embodiment of the present disclosure;

FIG. 8 is a flowchart illustrating a method of determining operating status of a host in the failure configuration strategy of a method of deploying microservice according to an embodiment of the present disclosure; and

FIG. 9 is a flowchart illustrating a load reduction stage of a method of deploying microservice according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

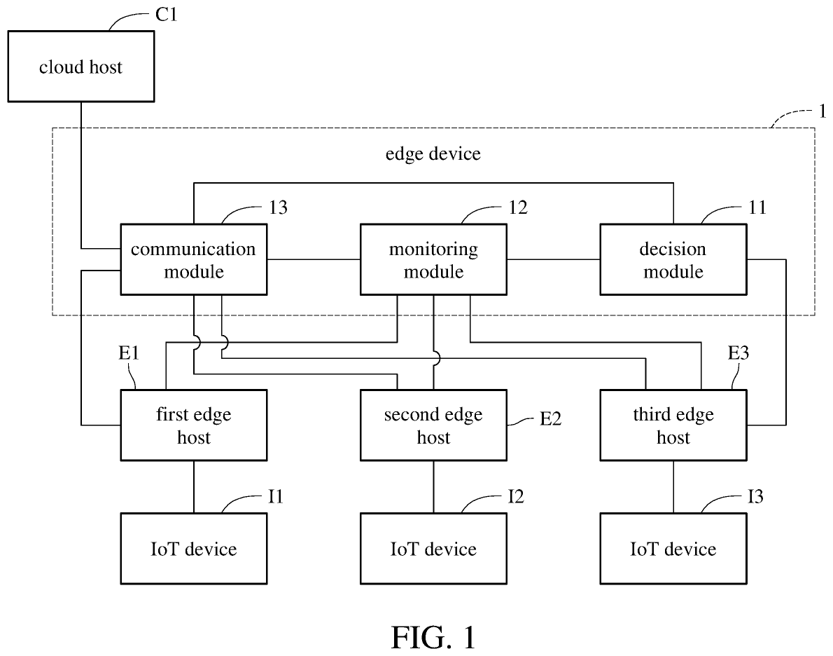

Please refer to FIG. 1, FIG. 1 is a functional block diagram illustrating operation environment of an edge device according to an embodiment of the present disclosure. As shown in FIG. 1, the edge device 1 includes a decision module 11, a monitoring module 12 and communication module 13. The decision module 11 is in communication connection with the monitoring module 12 and the communication module 13, and the monitoring module 12 is connected to the communication module 13, a first edge host E1, a second edge host E2 and a third edge host E3. The communication module 13 is configured to connect a cloud host C1 and the first edge host E1, the second edge host E2 and the third edge host E3. The decision module 11 and the monitoring module 12 may be connected to the cloud host C1 through the communication module 13. The number of edge hosts and The number of cloud host shown in FIG. 1 are only exemplary, the present disclosure is not limited thereto. The “edge host” described herein may be one of a plurality of processors (for example, a core unit of a multi-core processor) disposed in a same computing device or an independent computing device, and “cloud host” herein may be a virtual host.

The decision module 11, the monitoring module 12 and the communication module 13 may be implemented in a form of software, firmware or hardware, wherein the communication module 13 may be an application programming interface (API), and may communicate with API of the cloud. The monitoring module 12 may obtain the operating status and a respective current load of one or more task queues inside the first edge host E1, the second edge host E2 and the third edge host E3, and may obtain the operating status and a respective current load of one or more task queues inside the cloud host C1 through the communication module 13. One task queue corresponds to one computation category. Specifically, if there are N types of tasks, then there are N task queues, wherein N may be a non-negative integer. The number of tasks of each task queue may be used as an index of loading status, and the loading status of the task queue may be obtained through messaging server. The decision module 11 may deploy microservice at the edge side or/and cloud side according to (for example, by using) information obtained by the monitoring module 12. Specifically, each task queue corresponds to a certain type of microservice (for example, the task type described above), one task queue is generally processed by one microservice, but may also be processed by a plurality of microservices. Microservice is a stateless software element. When a microservice is operating, one task may be taken out from the corresponding task queue for calculation, and a result from the calculation may be sent to another task queue as a new task of said another task queue, and processed by another microservice. After a series of calculation is completed, the final result may be sent to a target location (for example, a databased or a storage system), wherein the task obtained by the fist one of the task queues usually comes from an Internet of things (IoT) device (for example, a sensor). A relationship between the task queue and the microservice may form a directed graph with a plurality of nodes. In addition, the microservice run by the computation resources at edge side (for example, one or more of the first edge host E1 to the third edge host E3) may be regarded as fog computing, and the microservice run by the computation resources at cloud side is cloud computing. By the functions of the above modules, the edge device 1 may provide microservice configuration strategies under the structure of cloud-fog collaboration.

The decision module 11, the monitoring module 12 and the communication module 13 may be executed by one or more processors or even one or more computers. That is, the edge device 1 may include one or more processors or even one or more computers. The edge device 1 may be a device disposed outside of the first edge host E1, the second edge host E2 and the third edge host E3; or, the edge device 1 may be at least one of the first edge host E1, the second edge host E2 and the third edge host E3.

The structure shown in FIG. 1 may be applied to various fields, such as smart aquaculture, smart factory, etc., the present disclosure is not limited thereto. For example, each one of the first edge host E1, the second edge host E2 and the third edge host E3 may be used to receive data of IoT devices I1 to I3 (such as sensor) in the field, and perform analysis, model training etc. with the data. The monitoring module 12 of the edge device 1 may monitor the operating status of the first edge host E1, the second edge host E2 and the third edge host E3, the decision module 11 deploys the microservices of the first edge host E1, the second edge host E2 and the third edge host E3 through the communication module 13 according to the operating status of the first edge host E1, the second edge host E2 and the third edge host E3, and further uses resources of one or more cloud hosts C1 based on deployment needs. In addition, FIG. 1 only exemplarily illustrates the first edge host E1, the second edge host E2 and the third edge host E3 connected to one IoT device respectively, but the present disclosure does not limit the number of IoT devices that each edge host is connected to.

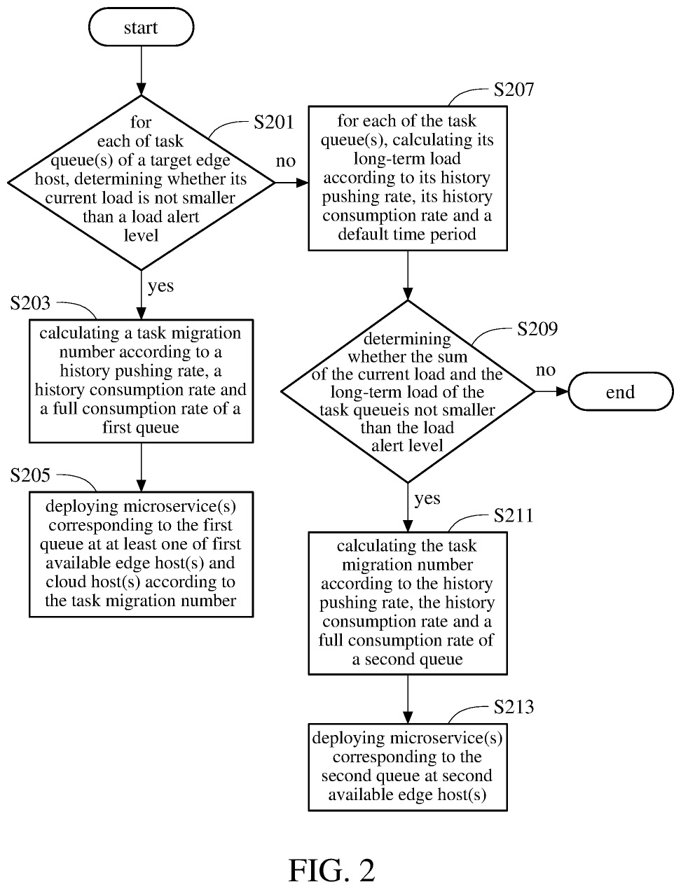

To explain the operation of the edge device 1 in more detail, please refer to FIG. 1 and FIG. 2, wherein FIG. 2 is a flowchart illustrating a method of deploying microservice according to an embodiment of the present disclosure. The method of deploying microservice shown in FIG. 2 may be performed by the edge device 1 shown in FIG. 1, for example, may be converted into commands or program codes to be performed by the edge device 1, and the method includes: step S201: for each of task queue(s) of a target edge host, determining whether its current load is not smaller than a load alert level; using the task queue with the determination result of step S201 being “yes” as a first queue and performing step S203: calculating a task migration number according to a history pushing rate, a history consumption rate, and a full consumption rate of a first queue; step S205: deploying microservice(s) corresponding to the first queue at at least one of first available edge host(s) and cloud host(s) according to the task migration number; if (e.g., when) the determination of step S201 of all the task queues are “no”, performing step S207: for each of the task queue(s), calculating its long-term load according to its history pushing rate, its history consumption rate and a default time period; step S209: determining whether the sum of the current load and the long-term load of the task queue is not smaller than the load alert level; using the task queue with the determination result of step S209 being “yes” as a second queue and performing step S211: calculating the task migration number according to the history pushing rate, the history consumption rate, and a full consumption rate of a second queue; step S213: deploying microservice(s) corresponding to the second queue at second available edge host(s); and if the determination result of step S209 is “no”, ending the method of deploying microservice. Said “not smaller than” herein is, for example, “equals to” or “greater than”. The “first” queue is the task queue determined as having the current load not smaller than the load alert level, and the “second” queue is the task queue determined as having the current load added with the long-term load not smaller than the load alert level, the two queues are not limited to be different task queue.

For better understanding the following uses the first edge host E1 as the target edge host E1 for example. It should be noted that, the edge device 1 may use each of the second edge host E2 and the third edge host E3 simultaneously or sequentially as the target edge host to perform the monitoring and deploying described below. The target edge host E1 may have one or more task queues to be processed, and each task queue has a corresponding current load, wherein the current load indicates the number of tasks to be processed of the task queue. In step S201, the decision module 11 determines whether the current load of each task queue of the target edge host E1 obtained from the monitoring module 12 is not smaller than the load alert level, wherein the load alert level indicates a maximum load of the task queue, or indicates a predetermined load (upper) limit.

If the decision module 11 determines that there is a task queue among said one or more task queues has the current load not smaller than the load alert level, the decision module 11 uses the task queue as the first queue, which is in a situation of short-term overload. The number of the first queue may be one or more, the following step S203 and step S205 are performed on each first queue. In step S203, the decision module 11 calculates the task migration number according to the history pushing rate, the history consumption rate and the full consumption rate of the first queue, wherein the task migration number indicates the number of tasks in the first queue that needed to be transferred, and may equal to the number of hosts that are available to take on the microservice(s) corresponding to the first queue. For example, the task migration number may indicate the number of hosts, among the second edge host E2, the third edge host E3 and the cloud host(s) C1, that are available to take on the microservice(s) corresponding to the first queue. In other words, the task migration number may also be regarded as a host transfer number, which equals to the number of hosts required for task transfer.

Specifically, the history pushing rate indicates a rate of pushing (or may be considered as “writing”) a task into the first queue before the time point corresponding to the current load, and the history pushing rate may be obtained by performing linear regression on a plurality of task pushing rates at a plurality of past time points; the history consumption rate indicates a rate of the target edge host E1 processing the tasks in the first queue before the time point corresponding to the current load, and the history consumption rate may be obtained by performing linear regression on a plurality of task processing rates at a plurality of past time points; the full consumption rate indicates a maximum rate of processing the first queue when the corresponding microservice(s) is not idling, or indicates an average rate of processing the first queue when the corresponding microservice(s) is not idling. The history pushing rate, the history consumption rate and the full consumption rate described above may be detected and recorded by the monitoring module 12 during the operation of the target edge host E1, and obtained by performing calculation on the collected data after records are collected, and may also be obtained by the decision module 11 by performing calculation on the collected data, which are obtained from the monitoring module 12. The decision module 11 may obtain the task migration number by the following equation (1):

$$the task migration number = \frac{α - β}{{β}_{full}} \qquad equation ( 1 )$$

wherein α is the history pushing rate; β is the history consumption rate; and β_{full} is the full consumption rate.

Then, in step S205, the decision module 11 deploys the at least one microservice corresponding to the first queue according to the task migration number at at least one of at at least one cloud host C1, the second edge host E2 and the third edge host E3 through the communication module 13. For example, assuming that the task migration number is 1, and the second edge host E2 and the third edge host E3 are both available edge hosts, then the decision module 11 may deploy the microservice(s) corresponding to the first queue at the second edge host E2, the third edge host E3 or the cloud host(s) C1 through the communication module 13; assuming that the task migration number is 2, and the second edge host E2 and the third edge host E3 are both available edge hosts, then the decision module 11 may deploy the microservice(s) corresponding to the first queue at two of the second edge host E2, the third edge host E3 and the cloud host(s) C1 through the communication module 13. After the deployment is finished, the decision module 11 builds a link between the deployed microservice(s) and the first queue. Especially, the available edge host described herein may indicate a processor with sufficient computing power or an idling computing device. The determination of whether the edge host is available may be performed by the monitoring module 12 or the decision module 11 based on operating data of each edge host gathered by the monitoring module 12. The deployment described herein may be implemented by auto scaling the microservice(s) or creating a new microservice(s).

Accordingly, the method of deploying microservice and the edge device 1 performing the method may transfer at least part of the tasks of any task queue with short-term overload to another host, to avoid the tasks from piling up at the target edge host E1 and even the problem of delay or that other tasks can't be written into the task queue.

If, in step S201, the decision module 11 determines that the respective current load corresponding to one or more task queues of the target edge host E1 are all smaller than the load alert level, then in step S207, the decision module 11 calculates the long-term load according to the respective history pushing rate, history consumption rate and default time period of each task queue.

Specifically, the contents and method of calculating the history pushing rate and the history consumption rate of each task queue are the same as those of the first queue described above, and their descriptions are not repeated herein; the default time period is used to predict the load of the task queue load at some point in the future, wherein the default time period is, for example, 1 minute to 60 minutes. For each task queue, the decision module 11 subtracts the history pushing rate from the history consumption rate of the task queue, and multiplies the difference with the default time period to obtain the long-term load.

In step S209, the decision module 11 determines whether a sum of the current load and the long-term load of each task queue is not smaller than the load alert level, to determine if there will be one or more task queues, among all of the task queues of the target edge host E1, with loads that are not smaller than the load alert level after the default time period has passed, and uses the task queue with the determination result of “yes” as the second queue. The second queue indicates a task queue with long-term overload (meaning that the tasks of the second queue are likely to exceed the load alert level after the default time period has passed). The number of the second queue may be one or more, and the subsequent step S211 and step S213 are performed on each second queue.

In step S211, the decision module 11 calculates the task migration number according to the history pushing rate, the history consumption rate and the full consumption rate of the second queue. The contents and method of calculating the history pushing rate, the history consumption rate and the full consumption rate of the second queue are the same as that of the history pushing rate, the history consumption rate and the full consumption rate of the first queue, and their descriptions are not repeated herein. The decision module 11 may obtain the task migration number of the second queue using equation (1) above.

Then, in step S213, the decision module 11 deploys at least one microservice corresponding to the second queue at at least one of the second edge host E2 and the third edge host E3 through the communication module 13 according to the task migration number. For example, assuming that the task migration number is 1, and the second edge host E2 and the third edge host E3 are both available edge hosts, then the decision module 11 may deploy the microservice(s) corresponding to the second queue at the second edge host E2 or the third edge host E3; assuming that the task migration number is 2, and the second edge host E2 and the third edge host E3 are both available edge hosts, then the decision module 11 may deploy the microservice(s) corresponding to the second queue at the second edge host E2 and the third edge host E3 through the communication module 13; assuming that the task migration number is 2, but only one of the second edge host E2 and the third edge host E3 is the available edge host, then the decision module 11 may only deploy the microservice(s) corresponding to the second queue at the available edge host. Accordingly, at least part of the tasks of the task queue of the target edge host E1 may be transferred to another host before the load of the target edge host E1 becomes too heavy, thereby avoiding the problem of delay and even the problem that other tasks of the target edge host E1 can't be written into the task queue. After the deployment is finished, the decision module 11 builds the link between the deployed microservice(s) and the second queue.

In short, step S203 and step S205 are similar to step S211 and step S213 respectively, only that step S203 and step S205 are performed when the task queue of the target edge host E1 is in the situation of short-term overload, and that the cloud computing resource may be selectively used to perform task transfer; and step S211 and step S213 are performed when the task queue of the target edge host E1 is in the situation of long-term overload, but only the edge host(s) is used to perform task transfer.

If in step S209, the decision module 11 determines that the sum of the current load and the long-term load of each task queue is smaller than the load alert level, it means that the target edge host E1 probably does not have the problem of task accumulation. Therefore, the decision module 11 may end the process shown in FIG. 2, or may perform step S201 after a period of time has passed.

According to the above embodiments, tasks of the target edge host E1 with the situation of short-term overload may be transferred to another host, and the task of the target edge host E1 with the situation of long-term overload may be transferred to another host in advance. Accordingly, the problem of task accumulation of the task queue of the target edge host E1 may be avoided, thereby avoiding progress delay of the target edge host E1.

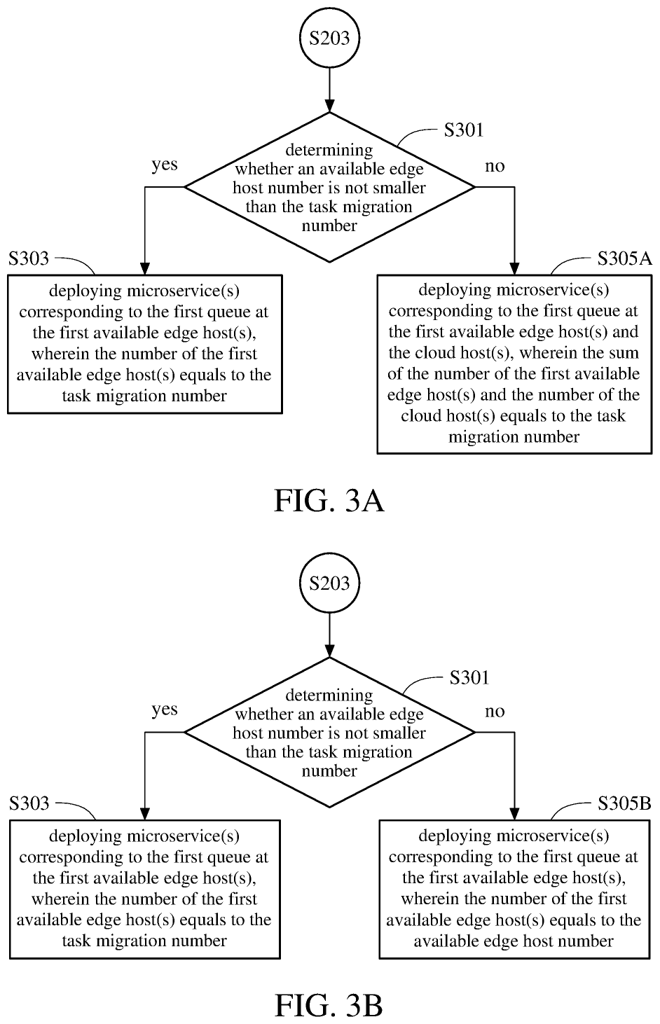

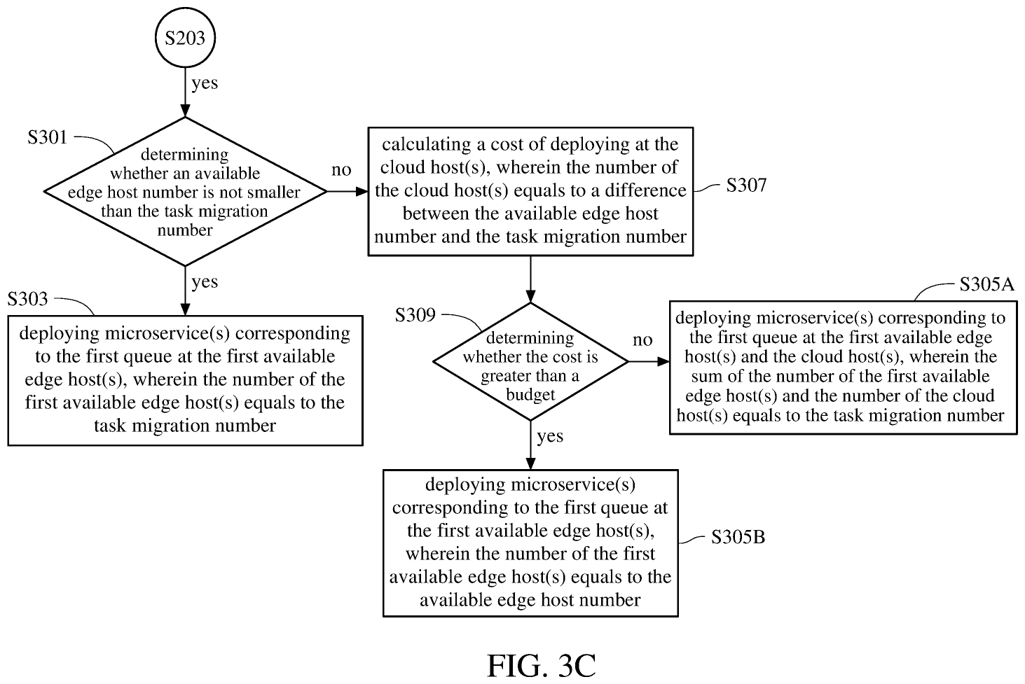

Please refer to FIG. 1 and FIG. 3A, wherein FIG. 3A is a flowchart illustrating a short-term overload configuration strategy of a method of deploying microservice according to an embodiment of the present disclosure. FIG. 3A may be regarded as a detail flowchart of an embodiment of step S205 of FIG. 2. As shown in FIG. 3A, after step S203 of FIG. 2, the method of the decision module 11 performing step S205 may include: step S301: determining whether an available edge host number is not smaller than the task migration number; if the determination result of step S301 is “yes”, performing step S303: deploying microservice(s) corresponding to the first queue at the first available edge host(s), wherein the number of the first available edge host(s) equals to the task migration number; and if the determination result of step S301 is “no”, performing step S305A: deploying microservice(s) corresponding to the first queue at the first available edge host(s) and the cloud host(s), wherein the sum of the number of the first available edge host(s) and the number of the cloud host(s) equals to the task migration number.

In step S301, the decision module 11 determines whether available edge host(s) is among the second edge host E2 and the third edge host E3, and whether an available edge host number, i.e., the number of the available edge host(s), is not smaller than the task migration number. If the number of the available edge host(s) is not smaller than the task migration number, in step S303, the decision module 11 may deploy the microservice(s) corresponding to the first queue at the first available edge host(s) among all available edge hosts, and the number of the first available edge host(s) equals to the task migration number. On the contrary, if the number of the available edge host(s) is smaller than the task migration number, in step S305A, the decision module 11 may deploy the microservice(s) corresponding to the first queue at the first available edge host(s) among all available edge host(s) and the cloud host(s) through the communication module 13, and the sum of the number of the first available edge host(s) and the number of the cloud host(s) equals to the task migration number. Accordingly, the cloud computing resource may be used to alleviate the problem of overload at the target edge host E1.

Please refer to FIG. 1 and FIG. 3B, wherein FIG. 3B is a flowchart illustrating a short-term overload configuration strategy of a method of deploying microservice according to another embodiment of the present disclosure. FIG. 3B may be regarded as a detail flowchart of another embodiment of step S205 of FIG. 2. Step S301 and step S303 shown in FIG. 3B are the same as step S301 and step S303 shown in FIG. 3A respectively, and are not repeated therein. As shown in FIG. 3B, after step S203 of FIG. 2, if the determination result of step S301 is “no”, performing step S305B: deploying microservice(s) corresponding to the first queue at the first available edge host(s), wherein the number of the first available edge host(s) equals to the available edge host number.

In step S305B, the decision module 11 may deploy the microservice(s) corresponding to the first queue at the first available edge host(s) through the communication module 13, and the number of the first available edge host(s) equals to the number of the available edge host(s). In other words, the decision module 11 may not deploy the microservice(s) corresponding to the first queue at the cloud host, and only deploy the microservice(s) corresponding to the first queue at the available edge host(s). Accordingly, the problem of the target edge host E1 overload may be alleviated, and cloud computing resources may not be needed.

Please refer to FIG. 1 and FIG. 3C, wherein FIG. 3C is a flowchart illustrating a short-term overload configuration strategy of a method of deploying microservice according to yet another embodiment of the present disclosure. FIG. 3C may be regarded as a detail flowchart of yet another embodiment of step S205 of FIG. 2. Step S301 and step S303 shown in FIG. 3C are the same as step S301 and step S303 shown in FIG. 3A respectively; and step S305A and step S305B shown in FIG. 3C may be the same as step S305A shown in FIG. 3A and step S305B shown in FIG. 3B respectively, and their descriptions are not repeated herein. As shown in FIG. 3B, after step S203 of FIG. 2, if the determination result of step S301 is “no”, performing step: S307: calculating a cost of deploying at the cloud host, wherein the number of the cloud host equals to a difference between the available edge host number and the task migration number; step S309: determining whether the cost is greater than a budget; if the determination result of step S309 is “no”, performing step S305A; and if the determination result of step S309 is “yes”, performing step S305B.

In step S307, the decision module 11 calculates the cost of deploying the microservice(s) corresponding to the first queue at the cloud host(s) C1, wherein the number of the cloud host(s) C1 equals to the difference between the number of the available edge host(s) and the task migration number.

Then, in step S309, the decision module 11 determines whether the cost is greater than the budget, wherein the budget may be a predetermined budget limit, the budget may also be the current remaining funds. If the cost is not greater than the budget, the decision module 11 performs step S305A; and if the cost is greater than the budget, the decision module 11 performs step S305B. In other words, in the embodiment of FIG. 3C, if the available edge host number is smaller than the task migration number, the decision module 11 may first calculate the cost of deploying the microservice(s) corresponding to part of the first queue at the cloud host(s) C1. If the cost is not greater than the budget, the microservice(s) that are not taken by the available edge host may be deployed at the cloud host(s) C1; if the cost is greater than the budget, the microservice(s) that are not taken by the available edge host may not be deployed at the cloud host. Accordingly, it is possible to use cloud computing resources to make up for short-term overloads in a situation where the edge computing resources aren't sufficient to handle and that the funds are sufficient. Even if the funds are insufficient, sharing all available edge computing resources may also alleviate the problem of overload. Said “not greater than” herein is, for example, smaller than or equals to.

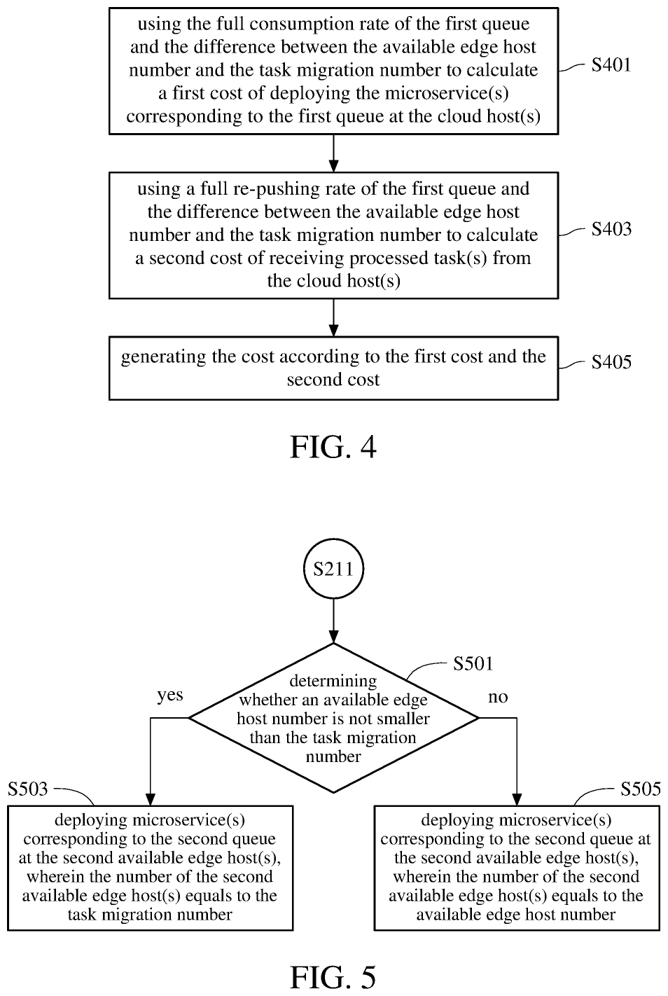

Please refer to FIG. 1 and FIG. 4, wherein FIG. 4 is a flowchart illustrating a cost calculation method in the short-term overload configuration strategy of a method of deploying microservice according to an embodiment of the present disclosure. FIG. 4 may be regarded as a detail flowchart of an embodiment of step S307 of FIG. 3C. As shown in FIG. 4, the method of calculating the cost of deploying the microservice at the cloud host C1 includes: step S401: using the full consumption rate of the first queue and the difference between the available edge host number and the task migration number to calculate a first cost of deploying the microservice(s) corresponding to the first queue at the cloud host(s); step S403: using a full re-pushing rate of the first queue and the difference between the available edge host number and the task migration number to calculate a second cost of receiving processed task(s) from the cloud host(s); and step S405: generating the cost according to the first cost and the second cost. It should be noted that, step S401 is illustrated as performed before step S403, but step S401 may also be performed after step S403, or performed with step S403 at the same time.

Specifically, for step S401, the decision module 11 may use the following equation (2) to obtain the number of the tasks to be uploaded (hereinafter referred to as “upload task number”):

the upload task number=β_{full}×q equation (2)

wherein β_{full} is the full consumption rate; q is the difference of subtracting the available edge host number from the task migration number, i.e., the required number of cloud host(s). The decision module 11 then obtains the first cost (i.e., uploading cost per unit time) according to the upload task number and the uploading fee per unit time, wherein different cloud computing resource providers may have different uploading fees per unit time, the present disclosure is not limited thereto. The unit of said “time” may be milliseconds, seconds, minutes or other time units, the present disclosure is not limited thereto.

Specifically, for step S403, the decision module 11 may use the following equation (3) to obtain the number of the tasks to be downloaded (hereinafter referred to as “download task number”):

the download task number=γ_{full}×q equation (3)

wherein γ_{full} is the full re-pushing rate, and may indicate a maximum rate of the non-idling microservice outputting the items corresponding to the tasks of the first queue, or indicate an average rate of the non-idling microservice outputting the items corresponding to the tasks of the first queue. The decision module 11 then obtains the second cost (i.e., downloading cost per unit time) according to the download task number and the downloading fee per unit time, wherein different cloud computing resource providers may have different downloading fees per unit time, the present disclosure is not limited thereto.

In step S405, the decision module 11 generates the cost described in step S309 of FIG. 5 according to the first cost and the second cost. Specifically, the decision module 11 may use the following equation (4) to obtain the cost:

$$cost = \frac{{I}_{now}}{{β}_{full} \times ( p + q )} \times R \qquad equation ( 4 )$$

wherein I_{now} is the current task number of the first queue; p is the available edge host number; I_{now}/β_{full}×(p+q) indicates time required for processing the current task number; R is the cost of using cloud computing resources per unit of time, and is, for example, calculated based on the first cost and the second cost described above, or calculated based on the first cost, the second cost and the cloud host usage, wherein different cloud computing resource providers may have different detailed calculation equation of the cost of using cloud computing resources per unit time, the present disclosure is not limited thereto.

Please refer to FIG. 1 and FIG. 5, wherein FIG. 5 is a flowchart illustrating a long-term overload configuration strategy of a method of deploying microservice according to an embodiment of the present disclosure. FIG. 5 may be regarded as a detail flowchart of an embodiment of step S213 of FIG. 2. As shown in FIG. 5, after step S211 of FIG. 2, the method of the decision module 11 performing step S213 may include: step S501: determining whether an available edge host number is not smaller than the task migration number; if the determination result of step S501 is “yes”, performing step S503: deploying microservice(s) corresponding to the second queue at the second available edge host(s), wherein the number of the second available edge host(s) equals to the task migration number; and if the determination result of step S501 is “no”, performing step S505: deploying microservice(s) corresponding to the second queue at the second available edge host(s), wherein the number of the second available edge host(s) equals to the available edge host number. The method of implementing step S501 may be the same as step S301 shown in FIG. 3A to FIG. 3C, and their description are not repeated herein. Specifically, the “second” available edge host is used to be distinguished from the “first” available edge host described in the configuration strategy of short-term overload, meaning they are determined as available edge hosts in different processes (methods), but “first” and “second” are not used to limit the two available edge hosts are two different available edge hosts, and are not used to limit the sequence of them determined as the available edge hosts in different processes.

If the decision module 11 determines that the number of the available edge host(s) is not smaller than the task migration number, the decision module 11, in step S503, deploys the microservice(s) corresponding to the second queue at the available edge host(s), wherein the number of the available edge host(s) is the task migration number.

If the decision module 11 determines that the number of the available edge host(s) is smaller than the task migration number, the decision module 11, in step S505, deploys the microservice(s) corresponding to part of the second queue at all available edge host(s). Through the above embodiment, the problem of task accumulation of the task queue of the target edge host E1 after the default time period has passed may be avoided. Further, since the risk corresponding to long-term overload is predictable, deployment may be performed with only the edge computing resources and not cloud computing resources, to lower the cost.

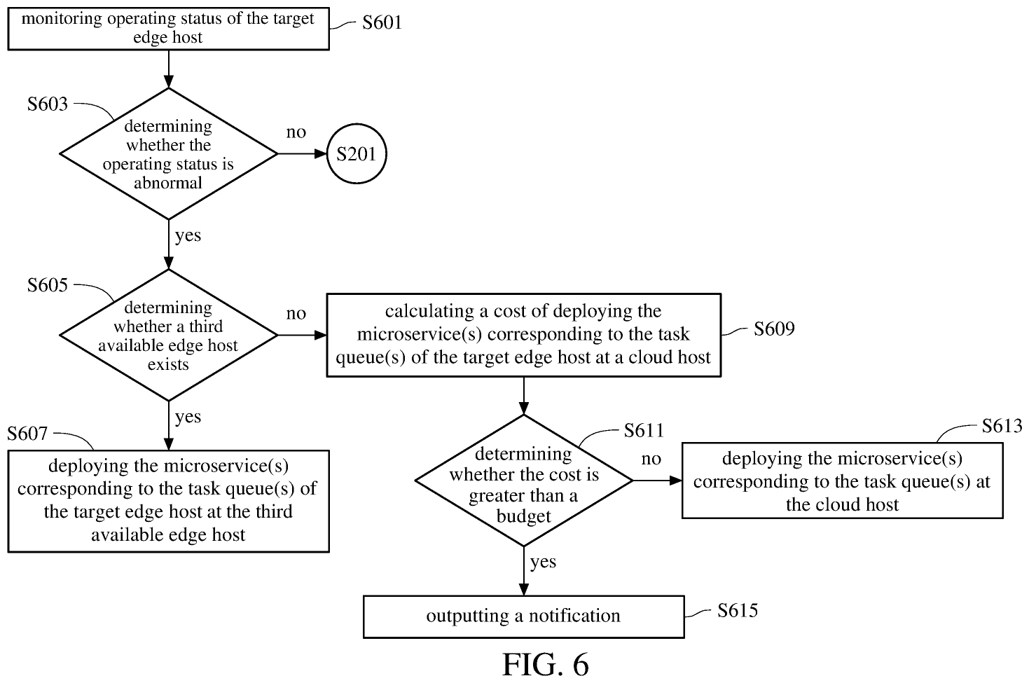

Please refer to FIG. 1 and FIG. 6, wherein FIG. 6 is a flowchart illustrating a failure configuration strategy of a method of deploying microservice according to an embodiment of the present disclosure. In addition to the above embodiments, the edge device 1 may further perform: step S601: monitoring operating status of the target edge host; step S603: determining whether the operating status of the target edge host is abnormal; if the determination result of step S603 is “no”, performing step S201 of FIG. 2; if the determination result of step S603 is “yes”, performing step S605: determining whether a third available edge host exists; if the determination result of step S605 is “yes”, performing step S607: deploying the microservice(s) corresponding to the task queue(s) of the target edge host at the third available edge host; if the determination result of step S605 is “no”, performing step S609: calculating a cost of deploying the microservice(s) corresponding to the task queue(s) of the target edge host at a cloud host; step S611: determining whether the cost is greater than a budget; if the determination result of step S611 is “no”, performing step S613: deploying the microservice(s) corresponding to the task queue(s) at the cloud host; and if the determination result of step S611 is “yes”, performing step S615: outputting a notification. The “third” available edge host is used to be distinguished from the “first” available edge host and the “second” available edge host described in the configuration strategy for short-term overload described above, meaning they are determined as available edge hosts in different processes (methods), but are not used to limit them as three different available edge hosts, and are not used to limit the sequence of them determined as the available edge hosts in different processes.

In step S601 and step S603, the monitoring module 12 monitors the operating status of the target edge host E1 and transmits the operating status back to the decision module 11. The decision module 11 determines whether the operating status of the target edge host E1 is abnormal. For example, the operating status may include CPU usage, GPU usage and/or memory capacity, etc., the present disclosure is not limited thereto. Take the above parameters for example, when the CPU usage, GPU usage and/or memory capacity reach their corresponding upper limit, the decision module 11 determines that the operating status of the target edge host E1 is abnormal. In addition, the decision module 11 may also determine that the operating status is abnormal when the target edge host E1 experiences failure.

If the operating status of the target edge host E1 is not abnormal, the decision module 11 may then perform step S201 of FIG. 2. In other words, determining whether the respective current load of at least one task queue of the target edge host E1 is not smaller than the load alert level may be performed when the operating status of the target edge host E1 is normal. If the operating status of the target edge host E1 is abnormal, the decision module 11 may then perform step S605 to determine whether third available edge host(s) is among the second edge host E2 and the third edge host E3, wherein the method of the decision module 11 determining whether there is third available edge host(s) may be the same as step S301 of FIG. 3.

If the decision module 11 determines that there is third available edge host(s) among the second edge host E2 and the third edge host E3, the decision module 11 deploys the microservice(s) corresponding to all of the task queues of the target edge host E1 at the third available edge host(s). That is, the decision module 11 transfers the task of the target edge host E1 to the third available edge host(s).

If the decision module 11 determines that the second edge host E2 and the third edge host E3 are not the third available edge host, then in step S609, the decision module 11 calculates the cost of deploying the microservice(s) corresponding to all of the task queues of the target edge host E1 at one cloud host C1.

Then, in step S611, the decision module 11 determines whether the calculated cost is greater than the budget, wherein the budget may be a predetermined budget limit, the budget may also be the current remaining funds. If the cost is not greater than the budget, the decision module 11 performs step S613 to deploy all of the task queues of the target edge host E1 at the cloud host(s) through the communication module 13. On the contrary, if the cost is greater than the budget, the decision module 11 performs step S615 to output a notification to a terminal device at the user end (for example, administrator of the operating environment of the edge device 1 or administrator of the edge device 1), the present disclosure does not limit the subject being notified.

In other words, in the embodiment of FIG. 6, if the operating status of the target edge host E1 is abnormal, it means that the target edge host E1 may not be able to process the task queue(s) normally. Therefore, the decision module 11 may first determine whether the microservice(s) corresponding to the task queue(s) of the target edge host E1 may be deployed at the available edge host(s). If the result of determination is “yes”, the decision module 11 performs said deployment at the available edge host(s); if the result of determination is “no”, the decision module 11 further determines whether there is enough budget to perform said deployment at the cloud host(s). If the result of determination is “yes”, the decision module 11 performs said deployment at the cloud host(s); if the result of determination is “no”, it means that there is no available edge host, and the budget is not enough to perform deployment at the cloud host, then the decision module 11 outputs the notification to the terminal device at the user end.

Through the embodiment of FIG. 6, when the operating status of the target edge host E1 is abnormal, the task of the target edge host E1 may be transferred to other hosts, and the task of the target edge host E1 may be transferred to the cloud host(s) when the budget is enough. Accordingly, the problem of task accumulation due to the failure of the target edge host E1 or even the problem of microservice stops operating may be avoided.

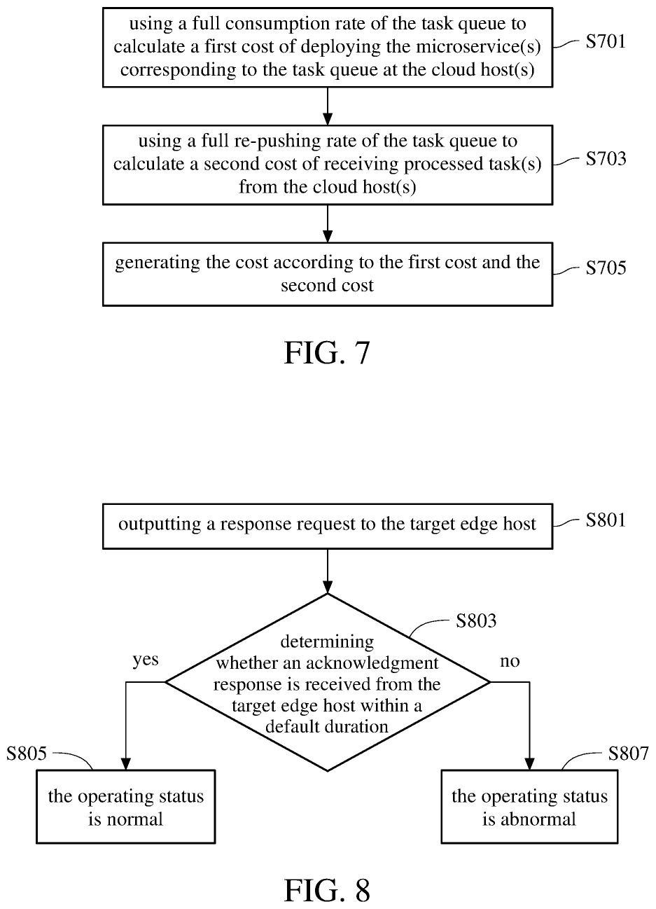

Please refer to FIG. 1 and FIG. 7, wherein FIG. 7 is a flowchart illustrating a cost calculation method in the failure configuration strategy of a method of deploying microservice according to an embodiment of the present disclosure. FIG. 7 may be regarded as a detail flowchart of an embodiment of step S609 of FIG. 6. As shown in FIG. 7, the method of calculating the cost of deploying the microservice(s) at the cloud host(s) includes: step S701: using a full consumption rate of the task queue to calculate a first cost of deploying the microservice(s) corresponding to the task queue at the cloud host(s); step S703: using a full re-pushing rate of the task queue to calculate a second cost of receiving processed task(s) from the cloud host(s); and step S705: generating the cost according to the first cost and the second cost. It should be noted that, step S701 is illustrated as performed before step S703, but step S701 may also be performed after step S703, or performed with step S703 at the same time.

In step S701, the decision module 11 may calculate the time (duration) required to upload the tasks corresponding to each task queue that is originally processed by the target edge host E1 to the cloud host(s) according to the full consumption rate of each task queue, and calculate the first cost according to said time and uploading cost per unit time.

In step S703, the decision module 11 may calculate the time (duration) required to download the tasks processed by the cloud host(s) according to the full re-pushing rate of each task queue originally processed by the target edge host E1, and calculate the first cost according to said time and uploading cost per unit time, and calculate the second cost according to said time and downloading cost per unit time. The full re-pushing rate indicates a maximum rate of the non-idling microservice outputting the items corresponding to the tasks of corresponding to the task queue, or indicate an average rate of the non-idling microservice outputting the items corresponding to the tasks of the task queue.

In step S705, the decision module 11 generates the cost described in step S611 of FIG. 6 according to the first cost and the second cost. Specifically, the decision module 11 may obtain the cost through the following equation (5):

$$cost = \frac{{I}_{now}}{{β}_{full}} \times R \qquad equation ( 5 )$$

wherein I_{now} is the current task number of the at least one task queue;

$$\frac{{I}_{now}}{{β}_{full}}$$

indicates the time (duration) required to process the current task number of tasks; R is the cost of using cloud computing resources per unit of time, and is, for example, calculated based on the first cost and the second cost described above, or calculated based on the first cost, the second cost and the cloud host(s) usage, wherein different cloud computing resource providers may have different detailed calculation equation of the cost of using cloud computing resources per unit time, the present disclosure is not limited thereto.

Please refer to FIG. 1 and FIG. 8, wherein FIG. 8 is a flowchart illustrating a method of determining operating status of a host in the failure configuration strategy of a method of deploying microservice according to an embodiment of the present disclosure. FIG. 8 may be regarded as a detail flowchart of an embodiment of step S601 of FIG. 6. As shown in FIG. 8, the monitoring module 12 monitoring the operating status of the target edge host E1 includes: step S801: outputting a response request to the target edge host; step S803: determining whether an acknowledgment response is received from the target edge host within a default duration; if the determination result of step S803 is “yes”, performing step S805: determining that the operating status is normal; and if the determination result of step S803 is “no”, performing step S807: determining that the operating status is abnormal.

In step S801, the monitoring module 12 outputs the response request to the target edge host E1 requesting the target edge host E1 to output a corresponding response back to the monitoring module 12 within the default duration, wherein the default duration is, for example, 10 seconds to 120 seconds, but the present disclosure is not limited thereto. In step S803, the monitoring module 12 determines whether a corresponding acknowledgment (ACK) response is received within the default duration.

If the monitoring module 12 receives the acknowledgment response from the target edge host E1 within the default duration, then in step S805, the monitoring module 12 determines that the operating status of the target edge host E1 is normal. If the monitoring module 12 does not receive the acknowledgment response from the target edge host E1 within the default duration, it means that the target edge host E1 may be experiencing a failure. In step S807, the monitoring module 12 determines that the operating status of the target edge host E1 is abnormal.

In addition, in step S801, the monitoring module 12 may further output the response request to the microservice(s) of the target edge host E1. If the monitoring module 12 receives the acknowledgment responses from the target edge host E1 and its microservice(s) within the default duration, step S805 is performed; if the monitoring module 12 does not receive the acknowledgment responses from the target edge host E1 and its microservice(s) within the default duration, step S807 is performed.

In addition, if the monitoring module 12 receives the acknowledgment response from the target edge host E1 but not from the microservice(s) within the default duration, it means that the target edge host E1 operates normally but its microservice(s) may be experiencing a failure. The monitoring module 12 may notify the decision module 11, and the decision module 11 may re-activate the microservice(s) of the target edge host E1 through the communication module 13.

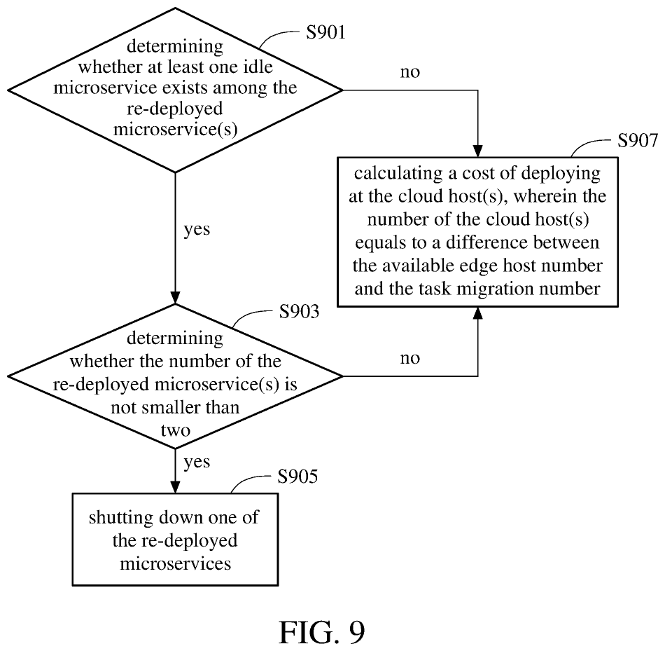

Please refer to FIG. 1 and FIG. 9, wherein FIG. 9 is a flowchart illustrating a load reduction stage of a method of deploying microservice according to an embodiment of the present disclosure. In the embodiment of FIG. 9, the microservice(s) corresponding to the first queue or the microservice(s) corresponding to the second queue includes a plurality of re-deployed microservices, wherein the re-deployed microservices are the microservices deployed at the available edge host(s) and/or the cloud host(s) according to the above embodiments. As shown in FIG. 9, the decision module 11 may further perform: step S901: determining whether at least one idle microservice exists among the re-deployed microservices; if the determination result of step S901 is “yes”, performing step S903: determining whether the number of the re-deployed microservices is not smaller than two; if the determination result of step S903 is “yes”, performing step S905: shutting down one of the re-deployed microservices; and if the determination result of step S901 is “no” or the determination result of step S903 is “no”, performing step S907: calculating a cost of deploying at the cloud host(s), wherein the number of the cloud host(s) equals to a difference between the available edge host number and the task migration number.

In step S901, the decision module 11 determines whether there are one or more microservices in the re-deployed microservices are idling, to determine whether there is idle microservice(s) among the re-deployed microservices. The decision module 11 may determine that a microservice(s) is idling when a duration of the microservice(s) not processing task queue(s) is not smaller than a predetermined duration.

If the decision module 11 determines that there is an idle microservice among the re-deployed microservices, then in step S903, the decision module 11 further determines whether the number of the re-deployed microservices at least equals to two. If the determination result of step S903 is “yes”, then in step S905, the decision module 11 shuts down one of the re-deployed microservices through the communication module 13. Furthermore, in step S905, the decision module 11 may shut down the microservice(s) deployed at the cloud host(s) when there is a microservice, among the re-deployed microservices, operated on the cloud host(s). In other words, when a cloud microservice operating on the cloud host(s) exists in the re-deployed microservices, the decision module 11 may prioritize shutting down the microservice(s) at the cloud host(s) to reduce the cost.

On the contrary, if the decision module 11, in step S901, determines that none of the re-deployed microservices are idling; the decision module 11, in step S903, determines that the number of the re-deployed microservices is smaller than two; or the decision module 11 has performed step S905, then the decision module 11 may then perform step S907.

In step S907, the decision module 11 calculates the cost of deploying the microservice(s) at the cloud host(s). That is, the decision module 11 may perform step S307 in FIG. 3C or step S609 in FIG. 6 to calculate the current cost of the microservice(s) that are already deployed at the cloud host(s). If the current cost is not smaller than the budget, the decision module 11 may shut down all microservice(s) on the cloud host(s) through the communication module 13, and notify the monitoring module 12 of performing step S601 of FIG. 6 again; and if the current cost is smaller than the budget, the decision module 11 may notify the monitoring module 12 of performing step S601 of FIG. 6 again.

Through the above structure, the method of deploying microservice and edge device of the present disclosure may perform monitoring for short-term (for example, immediately) overload and long-term overload, and transfer the task of the original edge host(s) with short-term overload to other edge host(s) or use cloud computing resources, thereby avoiding a new task entering the queue being rejected or abandoned; and transfer the task of the original edge host(s) with long-term overload to other edge host(s), thereby avoiding a future problem of task accumulation, allowing problems to be dealt with before they develop into serious immediate overload. In addition, the method of deploying microservice and edge device performing thereof according to one or more embodiments of the present disclosure may transfer the task of the target edge host to other host(s) when the operating status of the target edge host is abnormal, and selectively use cloud computing resources, especially when the budget is enough. Accordingly, not only task accumulation of the task queue at the edge host may be alleviated, a suitable microservice deployment strategy may be provided in accordance with the budget.

The above “first”, “second” and “third” are only used to distinguish the same statement (such as host, queue or cost), and are not used to limit any order between these statements, nor is it intended to limit any order in which the steps involved in these statements. There are various methods of implementing the modules in the edge device 1. For example, the modules therein can be integrated into one or more modules. In addition, the one or more modules may be implemented in the form of hardware (such as circuits, processors, controllers), software (such as commands or program codes) or firmware (such as a combination of hardware and software), and the present invention is not limited thereto.

Although the invention is disclosed by the aforementioned embodiments, they are not intended to limit the invention. Those skilled in the art will readily observe that numerous modifications and alterations of the method and the edge device may be made while retaining the teachings of the invention. Accordingly, the above disclosure should be construed as limited only by the metes and bounds of the appended claims.

What is claimed is:

1. A method of deploying microservice, performed by an edge device, comprising:
determining whether a current load of each of at least one task queue of a target edge host is not smaller than a load alert level;
when the current load of a first queue among the at least one task queue is not smaller than the load alert level, calculating a task migration number according to a history pushing rate, a history consumption rate and a full consumption rate of the first queue, and deploying at least one microservice corresponding to the first queue at at least one of at least one first available edge host and at least one cloud host according to the task migration number;
when the current load of each of the at least one task queue is smaller than the load alert level, calculating a long-term load of each of the at least one task queue according to a history pushing rate, a history consumption rate, and a default time period of a corresponding task queue, and determining whether a sum of the current load and the long-term load of the corresponding task queue is not smaller than the load alert level; and
when the sum of the current load and the long-term load of a second queue among the at least one task queue is not smaller than the load alert level, calculating the task migration number according to the history pushing rate, the history consumption rate and a full consumption rate of the second queue, and deploying at least one microservice corresponding to the second queue at at least one second available edge host.

2. The method of deploying microservice according to claim 1, wherein deploying the at least one microservice corresponding to the first queue at at least one of the at least one first available edge host and the at least one cloud host according to the task migration number comprises:
determining whether an available edge host number is not smaller than the task migration number;
when the available edge host number is not smaller than the task migration number, deploying the at least one microservice corresponding to the first queue at the at least one first available edge host, wherein a number of the at least one first available edge host equals to the task migration number; and
when the available edge host number is smaller than the task migration number, performing:
deploying the at least one microservice corresponding to the first queue at the at least one first available edge host and the at least one cloud host, wherein a sum of the number of the at least one first available edge host and a number of the at least one cloud host equals to the task migration number; or
deploying the at least one microservice corresponding to the first queue at the at least one first available edge host, wherein the number of the at least one first available edge host equals to the available edge host number.

3. The method of deploying microservice according to claim 2, further comprising:
when the available edge host number is smaller than the task migration number, calculating a cost of deploying at the at least one cloud host, wherein the number of the at least one cloud host equals to a difference between the available edge host number and the task migration number;
wherein when the cost is greater than a budget, deploying the at least one microservice corresponding to the first queue at the at least one first available edge host and the at least one cloud host; and
when the cost is not greater than the budget, deploying the at least one microservice corresponding to the first queue at the at least one first available edge host.

4. The method of deploying microservice according to claim 3, wherein calculating the cost of deploying the at least one cloud host comprises:
using the full consumption rate of the first queue and the difference between the available edge host number and the task migration number to calculate a first cost of deploying the at least one microservice corresponding to the first queue at the at least one cloud host;
using a full re-pushing rate of the first queue and the difference between the available edge host number and the task migration number to calculate a second cost of receiving a processed task from the at least one cloud host; and
generating the cost according to the first cost and the second cost.

5. The method of deploying microservice according to claim 1, wherein deploying the at least one microservice corresponding to the second queue at the at least one second available edge host comprises:
determining whether an available edge host number is not smaller than the task migration number;
when the available edge host number is not smaller than the task migration number, a number of the least one second available edge host equals to the task migration number; and
when the available edge host number is smaller than the task migration number, the number of the least one second available edge host equals to the available edge host number.

6. The method of deploying microservice according to claim 1, further comprising:
monitoring operating status of the target edge host;
when the operating status is abnormal, determining whether a third available edge host exists;
if the third available edge host exists, deploying at least one microservice corresponding to the at least one task queue at the third available edge host;
if the third available edge host does not exist, calculating a cost of deploying the at least one microservice corresponding to the at least one task queue at a second cloud host; and
when the cost is not greater than a budget, deploying the at least one microservice corresponding to the at least one task queue at the second cloud host;
wherein determining whether the current load of each of the at least one task queue of the target edge host is not smaller than the load alert level is performed when the operating status is normal.

7. The method of deploying microservice according to claim 6, wherein calculating the cost of deploying the at least one microservice corresponding to the at least one task queue at the second cloud host comprises:
using a full consumption rate of the at least one task queue to calculate a first cost of deploying the at least one microservice corresponding to the at least one task queue at the second cloud host;
using a full re-pushing rate of the at least one task queue to calculate a second cost of receiving a processed task from the second cloud host; and
generating the cost according to the first cost and the second cost.

8. The method of deploying microservice according to claim 6, wherein monitoring the operating status of the target edge host comprises:
outputting a response request to the target edge host;
determining whether an acknowledgment response is received from the target edge host within a default duration;
if the acknowledgment response is received from the target edge host within the default duration, determining the operating status is normal; and
if the acknowledgment response is not received from the target edge host within the default duration, determining the operating status is abnormal.

9. The method of deploying microservice according to claim 1, wherein the at least one microservice corresponding to the first queue or the at least one microservice corresponding to the second queue comprises a plurality of re-deployed microservices, and the method further comprises:
determining whether at least one idle microservice exists among the re-deployed microservices;
when the at least one idle microservice exists, determining whether a number of the re-deployed microservices is not smaller than two; and
when the number of the re-deployed microservices is not smaller than two, shutting down one of the re-deployed microservices.

10. The method of deploying microservice according to claim 9, wherein shutting down one of the re-deployed microservices comprises:
when a cloud microservice operating on the at least one cloud host exists in the re-deployed microservices, shutting down the cloud microservice.

11. An edge device, comprising:
a monitoring module configured to monitor operating status of a target edge host and a current load of each of at least one task queue of a target edge host;
a decision module connected to the monitoring module; and
a communication module,
wherein the decision module is configured to perform:
determining whether the current load of each of the at least one task queue of the target edge host is not smaller than a load alert level;
when the current load of a first queue among the at least one task queue is not smaller than the load alert level, calculating a task migration number according to a history pushing rate, a history consumption rate, and a full consumption rate of the first queue, and deploying at least one microservice corresponding to the first queue at at least one of at least one first available edge host and at least one cloud host through the communication module according to the task migration number;
when the current load of each of the at least one task queue is smaller than the load alert level, calculating a long-term load of each of the at least one task queue according to a history pushing rate, a history consumption rate, and a default time period of a corresponding task queue, and determining whether a sum of the current load and the long-term load of the corresponding task queue is not smaller than the load alert level; and
when the sum of the current load and the long-term load of a second queue among the at least one task queue is not smaller than the load alert level, calculating the task migration number according to the history pushing rate, the history consumption rate, and a full consumption rate of the second queue, and deploying at least one microservice corresponding to the second queue at at least one second available edge host through the communication module.

12. The edge device according to claim 11, wherein the decision module performing deploying the at least one microservice corresponding to the first queue at at least one of the at least one first available edge host and the at least one cloud host through the communication module according to the task migration number comprises:
determining whether an available edge host number is not smaller than the task migration number;
when the available edge host number is not smaller than the task migration number, deploying the at least one microservice corresponding to the first queue at the at least one first available edge host through the communication module, wherein a number of the at least one first available edge host equals to the task migration number; and
when the available edge host number is smaller than the task migration number, performing:
deploying the at least one microservice corresponding to the first queue at the at least one first available edge host and the at least one cloud host through the communication module, wherein a sum of the number of the at least one first available edge host and a number of the at least one cloud host equals to the task migration number; or
deploying the at least one microservice corresponding to the first queue at the at least one first available edge host through the communication module, wherein the number of the at least one first available edge host equals to the available edge host number.

13. The edge device according to claim 12, wherein the decision module is further configured to perform:
when the available edge host number is smaller than the task migration number, calculating a cost of deploying at the at least one cloud host, wherein the number of the at least one cloud host equals to a difference between the available edge host number and the task migration number;
wherein when the cost is greater than a budget, deploying the at least one microservice corresponding to the first queue at the at least one first available edge host and the at least one cloud host through the communication module; and
when the cost is not greater than the budget, deploying the at least one microservice corresponding to the first queue at the at least one first available edge host through the communication module.

14. The edge device according to claim 13, wherein the decision module performing calculating the cost of deploying the at least one cloud host comprises:
using the full consumption rate of the first queue and the difference between the available edge host number and the task migration number to calculate a first cost of deploying the at least one microservice corresponding to the first queue at the at least one cloud host;
using a full re-pushing rate of the first queue and the difference between the available edge host number and the task migration number to calculate a second cost of receiving a processed task from the at least one cloud host; and
generating the cost according to the first cost and the second cost.

15. The edge device according to claim 11, wherein the decision module performing deploying the at least one microservice corresponding to the second queue at the at least one second available edge host through the communication module comprises:
determining whether an available edge host number is not smaller than the task migration number;
when the available edge host number is not smaller than the task migration number, a number of the least one second available edge host equals to the task migration number; and
when the available edge host number is smaller than the task migration number, the number of the least one second available edge host equals to the available edge host number.

16. The edge device according to claim 11, wherein the decision module is further configured to perform:
reading the operating status of the target edge host;
when the operating status is abnormal, determining whether a third available edge host exists;
if the third available edge host exists, deploying at least one microservice corresponding to the at least one task queue at the third available edge host through the communication module;
if the third available edge host does not exist, calculating a cost of deploying the at least one microservice corresponding to the at least one task queue at a second cloud host; and
when the cost is not greater than a budget, deploying the at least one microservice corresponding to the at least one task queue at the second cloud host through the communication module;
wherein determining whether the current load of each of the at least one task queue of the target edge host is not smaller than the load alert level is performed when the operating status is normal.

17. The edge device according to claim 16, wherein the decision module performing calculating the cost of deploying the at least one microservice corresponding to the at least one task queue at the second cloud host comprises:
using a full consumption rate of the at least one task queue to calculate a first cost of deploying the at least one microservice corresponding to the at least one task queue at the second cloud host;
using a full re-pushing rate of the at least one task queue to calculate a second cost of receiving a processed task from the second cloud host; and
generating the cost according to the first cost and the second cost.

18. The edge device according to claim 16, wherein the monitoring module performing monitoring the operating status of the target edge host comprises:
outputting a response request to the target edge host;
determining whether an acknowledgment response is received from the target edge host within a default duration;
if the acknowledgment response is received from the target edge host within the default duration, determining the operating status is normal; and
if the acknowledgment response is not received from the target edge host within the default duration, determining the operating status is abnormal.

19. The edge device according to claim 11, wherein the at least one microservice corresponding to the first queue or the at least one microservice corresponding to the second queue comprises a plurality of re-deployed microservices, and the decision module is further configured to perform:
determining whether at least one idle microservice exists among the re-deployed microservices;
when the at least one idle microservice exists, determining whether a number of the re-deployed microservices is not smaller than two; and
when the number of the re-deployed microservices is not smaller than two, shutting down one of the re-deployed microservices through the communication module.

20. The edge device according to claim 19, wherein the decision module performing shutting down one of the re-deployed microservices comprises:
when a cloud microservice operating on the at least one cloud host exists in the re-deployed microservices, shutting down the cloud microservice through the communication module.
